(19) United States
(12) Patent Application Publication
(10) Pub. No.: US 2018/0186198 A1
(43) Pub. Date: Jul. 5, 2018

(54) External Mounting Intelligent Vehicle Tire Pressure Management System Apparatus

(71) Applicants: Joe Huayue Zhou, Hacienda Heights, CA (US); Steven Hiuman Wong, Cerritos, CA (US)

(72) Inventors: Joe Huayue Zhou, Hacienda Heights, CA (US); Steven Hiuman Wong, Cerritos, CA (US)

(21) Appl. No.: 15/396,066

(22) Filed: Dec. 30, 2016

(51) Int. Cl. B60C 23/00; B60C 23/04

(52) U.S. Cl. CPC B60C 23/003; B60C 23/0484; B60C 23/0486

(57) ABSTRACT

An finally mountable intelligent tire pressure management system (iTPMS) capable of real-time tire pressure monitoring, vehicle load detection, and automatic tire inflation and deflation for maintaining optimal tire pressure in a commercial vehicle. Additional functions include counting tire rotations for calculating and recording distance travelled for each tire, and detecting wheel sliding due to locked-up tires. The system includes a chassis-mounted control box connecting to the vehicle air supply, an external hubcap cover-mounted dual wheel valve apparatus integrated with a rotary union assembly that connects through the external bracket mounting structure holding the air tubes to the control box. The inflation/deflation supporting dual wheel valve apparatus has an embedded electronic unit that monitors individual tire pressure and temperature in real time, and communicates with the control box over the power and data line. Furthermore an external vehicle weight sensor interfacing with the control box provides the system with the current vehicle load information. With readily available real time tire pressure data and current vehicle load information, this system can intelligently adjusts tire pressure to the desired level when necessary and, as a result, prolongs tire life, improves fuel economy, reduces the vehicle maintenance costs, and promptly alerts the driver of low, leaky or flat tire conditions for enabling the driver to take immediate corrective actions.

### FIELD OF THE INVENTION

The present invention relates to external bracket-mounted vehicle tire pressure management systems with real time pressure monitoring and automatic pressure inflation and deflation functionalities. Particularly, the invention relates to an easily installable apparatus intelligently maintaining optimized tire pressure with respect to pressure variations, road conditions, and vehicle load conditions while the vehicle is in motion, plus the counting of tire rotations for measurement of distance traveled and detection of locked wheel situations.

### BACKGROUND OF THE INVENTION

Keeping proper tire pressure is a very important aspect of vehicle maintenance. Driving on underinflated or overinflated tires compromises stopping distance, ride and handling, fuel economy, tread wear, and load bearing. Over-inflation decreases traction, causes the tread to wear more quickly in the center, and wear suspension components faster. Underinflated tires have greater flex in the tires' sidewalls. Excessive deflection causes wear closer to the sides, leads to more heat buildup that speeding wear, and greatly reduces fuel economy. Each tire is rated to carry a maximum amount of weight at a prescribed tire pressure. When there is insufficient air pressure in a tire to support a specific load, the extra heat generated in the tire can cause it to fail. Properly inflated pressure during vehicle operation can achieve optimal tire deflection for the best grip and will help to provide even wear and longer life of the expensive tires with substantially improved fuel economy. The concept of a tire inflation system has been implemented on commercial and military vehicles for many years. Many military vehicles are equipped with a central tire inflation system (CTIS) which incorporates both inflation and deflation features, allowing the pressure of the tire to be manually adjusted in response to the road conditions experienced by a vehicle. For example, on relatively soft terrain, the tires could be deflated somewhat to improve traction. In contrast, on harder surfaces, such as paved roads, the tires could be more highly pressurized. Nevertheless, currently available central tire inflation systems do not have real time tire pressure monitor capabilities nor able to intelligently and automatically manage tire pressure with respect to pressure variation, vehicle load and terrain conditions. In addition, such CTIS can only be installed on specially designed wheels and therefore not applicable to common vehicles. For commercial vehicles, current tire inflation systems are designed to inflate tire pressure only. Their primary function is to ensure that tire pressure does not fall below a preset tire pressure. Without deflation capability, such systems often can only maintain a preset pressure when the tires were cold but unable to adjust the pressure when the tires got hot and might become overly inflated. Furthermore, one of the most important variables affecting the ideal amount of tire pressure is the load the vehicle tires need to carry but inflation-only system is unable to adjust the tire pressure in accordance to the vehicle load.

U.S. Pat. No. 6,145,559 issued to Rupert Henry Ingram on Nov. 14, 2000 discloses automated tire inflation by using a rotary union to connect a rotary axle and hub assembly. The assembly includes a rotary air connection assembly thread-ably mounted on the hubcap.

U.S. Pat. No. 6,585,019 B1 issued to Anthony L. Ingram on Jul. 1, 2003 discloses a rotary union assembly for use in an automatic tire inflation system for maintaining the desired pressure in the tires on a trailer or other vehicle having pressurized axles. The assembly communicates the valve stems on a pair of adjacent tires with the axle interior through the use of a flexible tube extending between a stationary first fitting thread-ably engaged in the axle spindle and a rotary housing secured against the outside end surface of the hubcap so as to be positioned exteriorly of wheel lubrication compartment and rotatable with the hubcap.

U.S. Patent US 2004/01732296 A1 issued to Jay D. White on Sep. 9, 2004 discloses a tire inflation system include an air supply in selective fluid communication with a tire via a pneumatic conduit. An inflation pressure of the tire is measured with a set-up procedure and the tire is inflated with an extended-pulse procedure.

U.S. Patent US 2006/0018766 A1 issued to Edmund A. Stanczak on Jan. 26, 2006 discloses a tire inflation system includes a hose that connects to a tire via a valve stem. A control valve is in fluid communication with the hose and senses when pressure falls below a predetermined minimum value. When this occurs, the control valve automatically opens to re-supply air to the tire until the predetermined minimum value is achieved.

U.S. Pat. No. 6,144,295 is issued to Brian Adams on Nov. 7, 2000 discloses a central tire inflation system for a work vehicle. The central tire inflation system controls the inflation pressure in the tires of a work vehicle. The central tire inflation system may be placed in an automatic or manual mode. In the automatic mode, the system make changes to the tire pressures according to the tire parameters, terrain conditions, and the operating loads placed on the tire.

U.S. Patent US 2007/0204946 A1 is issued to Martin A. Medley on Sep. 6, 2007 discloses a central tire inflation wheel assembly and valve. The valve includes a main body that is position-able in a sealed and recessed or embedded configuration within the aperture in the wheel rim in communication with the interior of the tire and with a pressurized air source that is used to inflate or deflate the tire.

Typically, these commercial tire inflation systems teach how to inflate air into tires through a rotary union with a one-way check valve that does not have tire deflation functionality. Such system mostly must operate continuously or periodically without knowing current tire pressure in individual tires. When inflation is not activated such systems are unable to detect any flat or leaky tire conditions. While military central tire inflation systems can perform tire pressure inflation and deflation functions, in order to avoid over burning the hub seal, these systems mostly can only check tire pressure during the periodic inflation and deflation activation time. Moreover, these teachings do not address nor provide intelligent tire management solutions to resolve many practical issues, as described below:

### (i) Tire Inflation and Deflation With Real Time Monitoring

Properly pressurizing and monitoring tires in real time are utmost important for driving safety and for prolonging the life of tires. However prior commercial tire inflation systems only inflate tires and do not monitor individual tire pressure. It is technically challenging to monitor each tire pressure in real time for tire inflation systems. Currently there are no commercially available tire inflation systems incorporating embedded electronic unit into each wheel valve assembly for monitoring individual tire pressure, and inflate or deflate the tires only when tire pressure is deviate from a predetermined optimal level. Prior teachings generally do not present practical methods to combine real time tire pressure monitor with tire inflation and deflation for commercial vehicle applications.

### (ii) Intelligent Tire Pressure Management

There are many tire inflating systems available on the market and most of them are designed for trailer installation with hollow axle and can't install to drive axle such as tractor. Such systems mostly use compressed air from the vehicle air tank to inflate tires when tire pressure fell below a preset level. Air from the existing trailer air supply is routed to a control box and then fed into air tubes installed inside each hollowed trailer axle. The air tubes run through the axles to carry air through a rotary union assembly joined at the end of the wheel spindle in order to distribute air to each tire via the valve stem. Generally tire inflation systems do not support intelligent tire pressure management, must inflate the tires continuously or periodically for every trip, and often overly inflate the tires.

Existing tire inflation systems generally use an in-line flow sensor to monitor air flow and do not have direct pressure readings from the tires for controlling the inflation, therefore such systems typically do not know if preset pressure was maintained in the tires. Mostly such systems would deduce that there might be leaky or flat tires if overall pressure was still low after inflating a period of time. This indirect detection of air leak and flat tire is unreliable and usually belated. With frequent system operation, the excessive work load putting on the rotary hub seal unit and the air compressor will wear out the parts sooner and would lead to more expensive vehicle maintenance and even unsafe driving conditions. A tire inflation and deflation system integrated with real tire pressure monitor manages pressure intelligently based on real-time tire pressure data and vehicle load, adjusts tire pressure only when necessary and, as a result, works less and thereby reduces the vehicle maintenance costs. More importantly such an intelligent system improves vehicle safety for it would be able to promptly alert the driver low, leaky or flat tire conditions and enabling the driver to take immediate corrective actions.

U.S. Pat. No. 9,248,707 issued to Joe H. Zhou and Steven H. Wong on Feb. 2, 2016 discloses an intelligent tire management system with automatic inflation and deflation functionalities that will resolve the many practical issues described above. However this system requires feeding the air lines through the hollow axles for connection to the hubcap and, therefore, cannot be installed on a vehicle with drive axles. In addition, this system is suitable for manufacturers installing on new trailers but too labor intensive for retrofitting vehicles in use. Thus an improvement on such an intelligent system with external mounting capacity would be a better solution for retrofitting trucks and trailers.

### SUMMARY OF THE INVENTION

A main object of the present invention is to provide an external bracket mounting intelligent tire pressure management system with automatic and manual tire pressure inflation and deflation functionalities for commercial vehicles. Such a system is capable of keeping tires of an operating vehicle in a user-defined optimal pressure level in response to real-time tire pressure changes, vehicle load and terrain conditions. The main components of this system consists of an in-cab monitor with digital display, a chassis mounting central control module that connects to the vehicle air tank, one wheel valve assembly for each dual tire that are incorporated into a hubcap mounting apparatus with a built-in rotary union, and an external bracket mounting apparatus to support the connection of air lines and power line between the central control module and the wheel valves connecting to the tires. This special wheel valve with embedded pressure monitoring electronics is pneumatically controllable by the central control module for opening and closing the air passages, thereby achieving the inflation or deflation of each tire in real time.

Another object of the invention is integrating load sensors into the intelligent tire management system for monitoring vehicle load and, accordingly, inflating or deflating the tire pressure to the user defined or tire manufactory recommended ideal pressure. Real-time vehicle load information provided by the system enables the driver to readily determine before a trip if the load being transported is consistent with the vehicle limitations and whether vehicle weight regulations are met. Beneficially, the vehicle operator no longer needs to spend the time and expense at weigh stations.

Another object of the invention is a method for electronically detecting and counting each set of wheel's rotation and sending the count back to the central control unit for detecting wheel sliding caused by locked up wheels, and for calculating tire distance traveled and thereby facilitating regular tire maintenance. In addition, this method supports calculating tire speed for the system to control pressure settings in accordance to terrain condition.

Another object of the invention is a method for system communication and power supply to the wheel valve electronic unit by using wire connecting the central control unit and the hubcap mounting rotary wheel valve. System with battery-less electronic assembly and power line communication is more reliable and needs less maintenance.

Another object of the invention is to provide a central control unit with electronic circuitry, pressure transducer, control valves and manifold for collecting tire pressure and temperature readings, measuring vehicle load, recording wheel rotation count, controlling tire inflation and deflation, and communicating tire management information through the power line. The central control unit is the brain of the intelligent tire management system.

Another object of the invention is a method and associated apparatus for externally mounting the intelligent tire management system on a commercial truck or semi-trailer with dual wheels.

### BRIEF DESCRIPTION OF THE DRAWINGS

FIG. 1a shows an intelligent tire management system installed on a truck with two drive axles.

FIG. 1b shows the electronic control manifold of installed system.

FIG. 1c shows the in-cab system monitor-controller.

FIG. 2a shows two isometric views of the rotary wheel valve assembly.

FIG. 2b is a drawing for the rotary mechanical face seal component of the rotary wheel valve assembly.

FIG. 2c is a cross-sectional drawing for the rotary mechanical face seal component of the rotary wheel valve assembly.

FIG. 3 is a cross-sectional drawing of the rotary wheel valve assembly mounted inside the hubcap cover with the air hose connector on the outside.

FIG. 4a is an angled cross-sectional side view of the rotary wheel valve assembly.

FIG. 4b is a cross-sectional top view drawing of the rotary wheel valve assembly.

FIG. 5 is a component drawing of the hubcap cover with the inside rotary wheel valve assembly and outside air hose connector.

FIG. 6 is a drawing showing the truck chassis mounting bracket connecting to the rotary wheel valve assembly in the wheel-mounted hubcap cover via a air hose connector.

FIG. 7 is a view of the bracket mounting assembly.

FIG. 8 is a view of the electronic grounding path.

FIG. 9 is an isometric view of the electronic manifold controller secured on a mounting plate.

FIG. 10 is an isometric view of the electronic manifold controller with cover lifted and showing the inside.

FIG. 11 is an isometric view of the manifold block of the electronic manifold controller with major components removed.

FIG. 12 is an angled cross-sectional view of the manifold block of the Electronic manifold controller.

FIG. 13 is the schematic of the rotary wheel valve electronic circuitry.

FIG. 14 is the schematic of the electronic manifold controller circuitry.

FIG. 15 is the schematic of the wheel valve sensor signal receiving section in the electronic manifold controller circuitry

### DETAILED DESCRIPTION OF THE INVENTION

An embodiment of the invention is described herein with references to the figures using reference designations as shown in the figures.

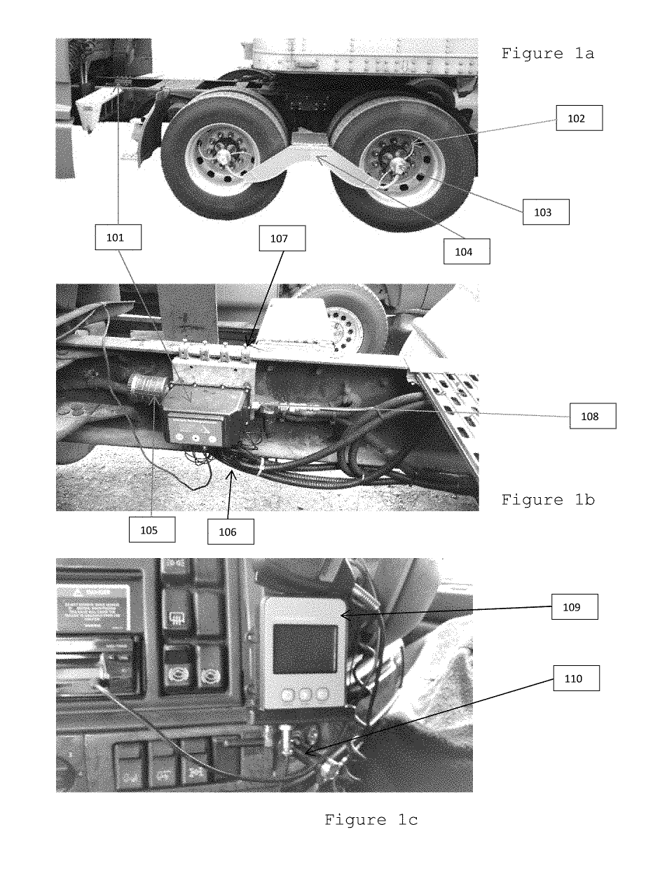

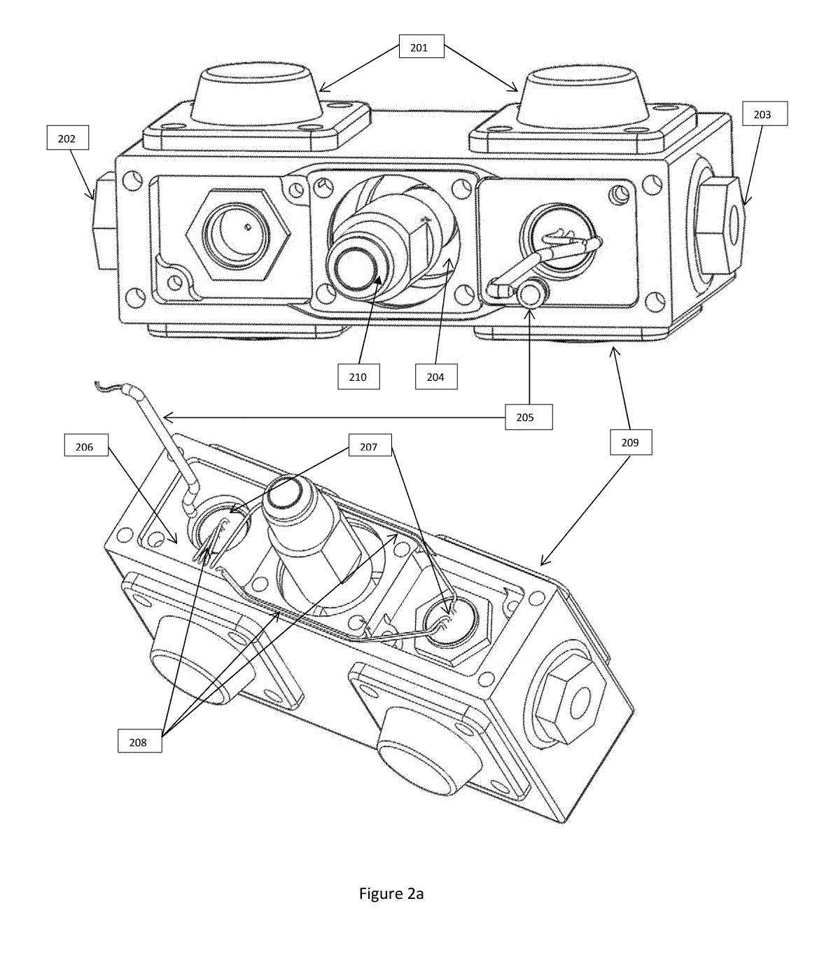

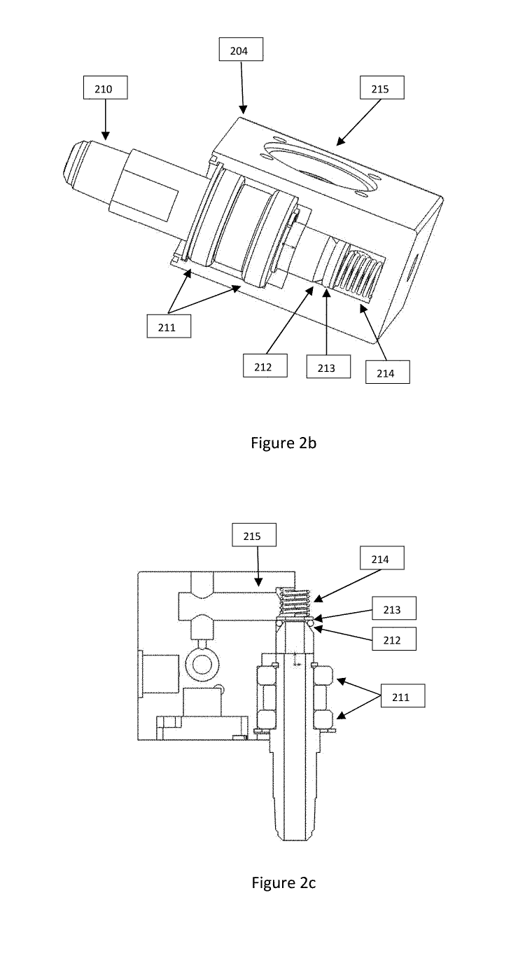

FIG. 1a shows an intelligent tire management system installing on a truck chassis with two drive axles, where 101 is an electronic manifold controller for automatically controlling air inflation and deflation to all the drive axle tires, 102 is the air hose from wheel valve 103 to tire valve stems, 104 is the mounting bracket with two wing shape flaps for securing and guiding the air hose and signal cable that provide air path and signal communication between the electronic manifold controller and the wheel valves. FIG. 1b shows electronic manifold controller 101 that gets pressurized air supply for inflation through air inlet 108 coming from the vehicle air compressor or releases air to the atmosphere for deflation through air outlet 105. Electronic manifold controller 101 also has multiple air outlets with each outlet communicating to a tire or a dual tire set through tubing 106 that laid within an external mounting apparatus along the vehicle chassis through mounting bracket 104, and eventually connecting to hubcap mounted rotary wheel valve assembly 103, which has air outlets connecting through hoses 102 to individual tire valve stems. Rotary wheel valve assembly 103 can open and close the air flow for tire inflation/deflation via its built-in wheel valves that are pneumatically controllable by electronic manifold controller 101. FIG. 1c shows display control unit 109 mounting in the truck cabin for monitoring and operating the system. Connector 110 is for connecting unit 109 with power and with signal cables to electronic manifold controller 101.

FIG. 2a shows two different angled views of a rotary wheel valve unit 209 having two built-in wheel valves, rotary union, pressure and temperature sensors, magnetic sensor and the electronic control circuitry; each rotary wheel valve unit can support one or two tires. Underneath removable covers 201 there are two built-in wheel values (not visible in FIG. 2a) for controlling the opening and closing of the air path between the electronic manifold controller 101 (FIG. 1a) and the tires; there are air passages inside rotary wheel valve 209 connecting the values to its respective air outlets 202 and 203 and then to the dual tires. Rotary union assembly 204 with a tubular shaft 210 is installed into a cavity in the rotatable rotary wheel valve base. The tubular shaft 210 with a central air passage is connected with the air tube from electronic manifold controller 101. Two print circuit boards (PCB) 207 with sensors exposed to the respective air passage connecting to the respective tire are responsible for monitoring tire pressure and temperature in real time. Sensor output connection wires 208 for PCB 207 are connected to PCB 206, which contains the electronics that controls the sensors and communicates to electronic manifold controller 101. The positive terminal of PCB 206 is electrically connected to the tubular shaft 210 through the rotary wheel valve base and the rotary union. A wire connecting electronic manifold controller 101 to the tubular shaft 210 supplies power to PCB 206 and on the same wire supports electronic data and control signal communication between electronic manifold controller 101 and PCB 206. Rotary wheel valve unit 209 is electrically insulated from the wheel hubcap top where it is mounted. To provide electrical grounding to PCB 206, wire 205 is connected with the hubcap cover through a built-in rotary brusher and from there to the grounding wire. FIGS. 2b and 2c are detailed drawings of rotary union assembly 204 for installing in a cavity of the rotary wheel valve base with half of the rotary shaft exposed to outside. Shaft 210 is secured and support by bearings 211 in the housing in a way that the shaft can be stationary while the housing with the attached rotary wheel valve base can be rotatable. The shaft has in the housing end a seal face 212 that is facing an opposite seal face 213 for defining a rotary mechanical sealing interface, with spring 214 putting pressure on the back of seal face 213 for keeping a tight seal. The chamber containing spring 214 and behind seal face 213 has air passage 215 leading to the valves. Each seal face has a central opening for air to pass through while one section is rotating and the other section is stationary. Now electronic manifold controller 101 can pneumatically control the opening and closing of the rotary wheel valves to direct air flow from the air source through the manifold, the air tubes, the rotary shaft central passage, the mechanical seal face central openings, the valves and finally reaching the tires, or the other way around.

Sensors are installed in the air passage between the respective valve and the air outlet; each sensor is exposed to air from the respective tire for monitoring individual tire pressure and temperature. The wheel valve electronics were powered by the electronic manifold controller via a wire connecting to the metal rotary shaft that is attached to the metal rotary wheel valve body. Thus the rotary wheel valve assembly is used as an electrical positive voltage power terminal for powering the electronics. The assembly includes electrical insulation sheets placing between the rotary wheel valve and hubcap for electrically insulating the rotary wheel valve with the metal hubcap. For electrical grounding, the PCB ground terminal wire will be connected with carbon bushes wiring back to the electronic control manifold.

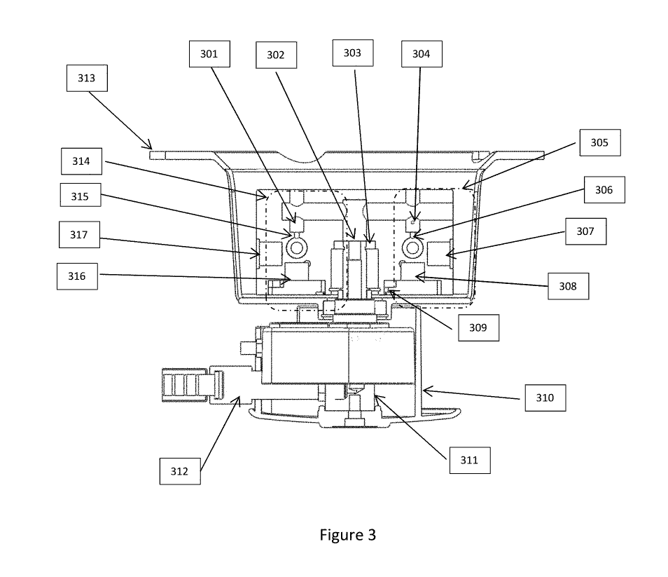

FIG. 3 is a sectional drawing of a rotary wheel valve assembly with hubcap cover for illustrating air distribution within this apparatus. The rotary wheel valve assembly is secured inside hubcap cover 313. The two values underneath covers 201 showed in FIG. 2a are indicated in FIG. 3 by two areas surrounded by dash lines 305 and 314. Air hose connector 310 affixed on hubcap cover 313 connects external air hose to the rotary wheel valve assembly in the hubcap cover. For inflating tires, air from the electronic manifold controller 101 (FIG. 1a) with pressure passes through the air hose and enters inlet 312 connecting to rotary shaft 303, flows through an air passage inside the rotary shaft, passes through rotary mechanical seal 302, flows into cavity 301,304 and then flows into two separate air distribution passage 307 and 317 next to the respective wheel valve, from there air flows through small orifices 306 and 315 and into wheel valves 308 and 316. The higher air pressure forces wheel values 308 and 316 to open and allows air flowing into air outlets 307 and 317 for filling the connecting tires. Regular air valves only control one way flow and can only be opened by higher source pressure.

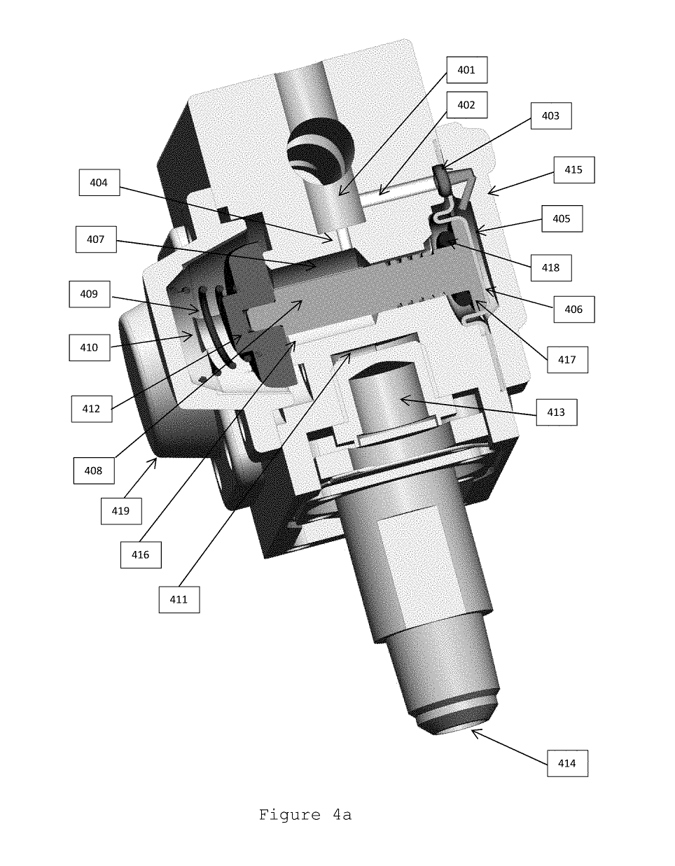

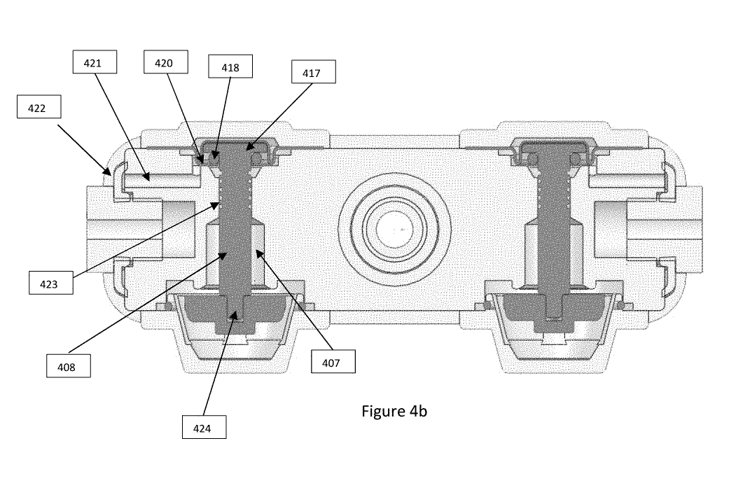

FIG. 4a is a rotary wheel valve assembly cross-section side view showing the built-in wheel valve structure in detail. There are two valve bodies built into two cavities in the rotary wheel valve assembly unit, with the rotary union fitting into an additional middle cavity. This drawing shows a valve cross-section view from the narrow side and therefore the rotary union is not visible. A wheel valve has three chambers. The top chamber 410 is under removable cover 419 on one broad side of the rotary wheel valve housing and the bottom chamber 405 is under removable cover 415 on the opposite side. Top chamber 410 has a poppet 412 that sits on seat 416 and separates the top chamber from the middle chamber 407. The middle chamber 407 contains a movable piston 408 with a large base 417 disposed against a flexible diaphragm 406 that separates the bottom chamber 405 from the middle chamber 407; the other end of the piston forms into a slender tip that fits into a cavity on the underside of poppet 412. The lower portion of the middle chamber 407 shapes into a cylinder tube 423 (FIG. 4b), which has a tight clearance between the cylinder wall and the piston 408 for restricting middle chamber air getting through to the piston base area. The bottom chamber 405 connects to the source air distribution passage 401 through air passage 402, whereas the middle chamber 407 also connects the source air distribution passage 401 but through orifice 404. Top chamber 409 connects to air passage 411 that leads to the tire port outlet. Spring 409 inside top chamber 409 is disposed under the cover 419 and pressed against poppet 412. Pressure sensor 413 is for monitoring air passage 411 to obtain real time pressure and temperature of the connecting tire. Sealing O-Ring 403 is for preventing chamber air and passage way air leaked through the gap between removable valve cap 415 and the apparatus body. When pressurized air flows into the bottom chamber 405, the pressure exerting through the flexible diaphragm 406 on piston base 417 will force the piston 408 to move upward against poppet 412. When the wheel valve is not pressurized, spring 409 will exert pressure on poppet 412, force the poppet to sit on the seat 416 and thereby close the valve. Otherwise, if the combined tire pressure and spring 409 pressure are smaller than the combined middle chamber 407 air pressure and the upward force exerting on poppet 412 that is produced by the bottom chamber 405 air pressure applying through piston 408, poppet 412 will be forced to move upward and unseat from the seat 416, thereby open the valve and allow air communication between the tire and the air source.

FIG. 4b shows that above piston base 417 there is a sealing o-ring 418, next to the o-ring there is a small cavity 420 with a breathing hole 421 leading to atmosphere. Dust cover 422 is for covering up the breathing hole. When piston 408 moves toward poppet 412, o-ring 418 will seal off the cylinder base and prevent air leakage from the middle chamber to cavity 420. However, even though there is a tight clearance between piston 408 and cylinder 423 and the piston base o-ring 418 would provide a good air seal, air in the middle chamber 407 could still seep through and reach cavity 420 and causing pressure build-up in the cavity that would counteract the bottom chamber 405 pressure through diaphragm 406, thereby affecting the effectiveness of the piston upward movement. Therefore it is important to release any build-up air in cavity 420 to the atmosphere.

As described above, the wheel valve supports two-way air communication. For deflating the tires, air flows in a direction from the higher pressure tires back to the electronic manifold controller and then to the atmosphere. If the source air pressure is lower than the target tire pressure in top chamber 409, the valve can be opened by the combined source air pressure in chamber 407 and the additional push-up force exerting on poppet 412 that is produced by the bottom chamber 405 air pressure applying through piston 408. This wheel valve design can support pneumatically controllable opening of the valve and releasing of tire air with a source air pressure at ⅔ or more of the tire pressure. For tire deflation applications, the electronic manifold controller can monitor the tire pressure in real time and maintain proper source air pressure accordingly for keeping the wheel valves open to release tire air. During deflation, the electronic manifold controller will open the solenoid deflation valve and release air to atmosphere through the deflation orifice. In this way high tire pressure can be gradually reduced to a desirable level.

The wheel valve can be quickly closed when source air is rapidly withdrawn, causing source air pressure to be less than ⅔ of tire pressure. When source air is withdrawn, orifice 404 limits air in the middle chamber 407 from flowing out too quickly, whereas the air in bottom chamber 405 will escape faster and loss the pressure to push up piston 408, leading to the lowering of poppet 412 to sit on seat 416 and thereby close the valve.

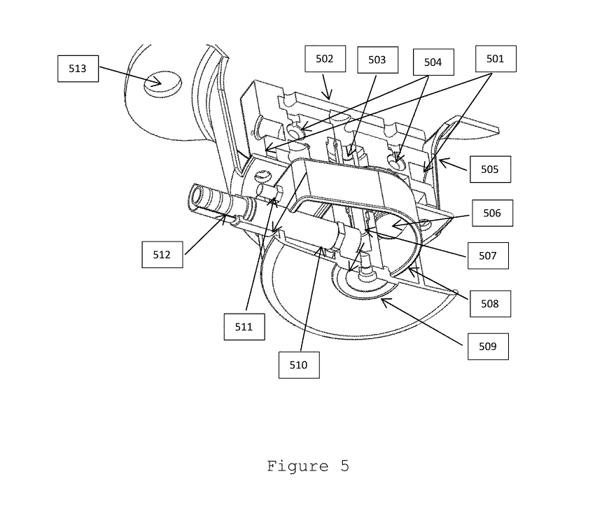

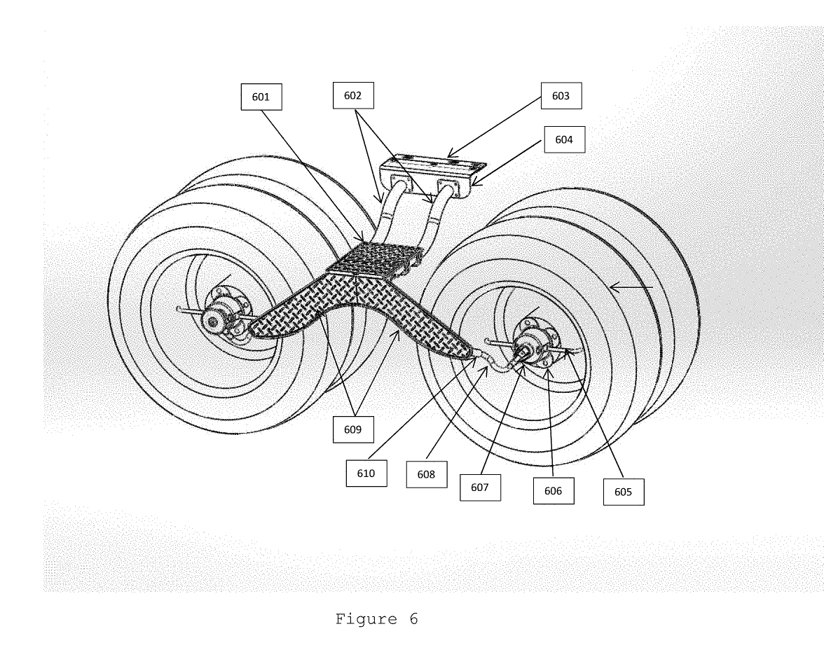

FIG. 5 is a drawing showing hubcap cover 505 with rotary wheel valve assembly mounted inside. Rotary wheel valve body 502 has two wheel valves 504 and rotary union shaft 503 with an air inlet (See FIG. 2a). The two tire ports 501 have hose fittings. Rotary union shaft 503 and wheel valve body 502 are to be electrically insulated from hubcap cover 505. A magnet 506 is embedded on the underside of the stationary air hose connector. The magnet sensor in the rotatable wheel valve electronics can detect the presence of magnetic field when passing by the magnet during wheel rotation, thereby enabling the counting of wheel rotation for calculating tire usage. Another function of detecting wheel rotation supports locked wheels detection during extremely cold weather conditions. The 510 and 512 provides air hose fitting. Connector 511 supports external wire connection for rotary wheel valve assembly electronics power supply and signal communication. There are 4 holes 513 for securing cover 505 with bolts on a truck drive axle hubcap. A 90 degree air pipe 507 connects to air tubing 510. After mounting on a hubcap and connecting to the electronic manifold controller through air hose and wire, this apparatus enables continuous air and signal communication between the wheel valves and the electronic manifold controller while the truck is moving.

FIG. 6 is a drawing showing bracket mounting assembly, flat metal plate with bolt slots 603 can be mounted on a truck's 5th wheel bolt rail bracket for attachment, the L shape metal plate 604 affixed on 603 is for mounting two metal tubes 602. Top cover plate 601 is mounted on top of metal tubes 602 for supporting the two wing shape flaps 609 with hinges. The hinge joining cover plate 601 and flap 609 allows each flap to be lifted up for tire service and put down for covering and protecting the tubing and the air hose inside. The inner side of each flap 609 is attached with a rigid tube 610. Flexible tube 608 has one end connecting to the rigid tube 610 and the other end connecting to hubcap cover with wheel valve assembly 607 for air hose connection providing air communication to and from hubcap cover with wheel valve assembly 607, which controls air path opening and closing to tires through valve stem hose 605. The 606 indicates the 4 holes for easy bolt mounting on a truck's drive axle hubcap. Air hoses and with buddle signal wires can be fed through this mounting bracket structure for supporting air and signal communication between the electronic manifold control box (not shown) with the wheel valve assembly 607. When the air hose and flexible tube were detached from 607, the side covering flap 609 can be lifted up for wheel valve assembly installation and install/removal of tires. This external mounting design enables easy installation of the intelligent tire pressure management system without needing to modify the vehicle in any way, and an installed apparatus has a very nice and natural appearance on a truck.

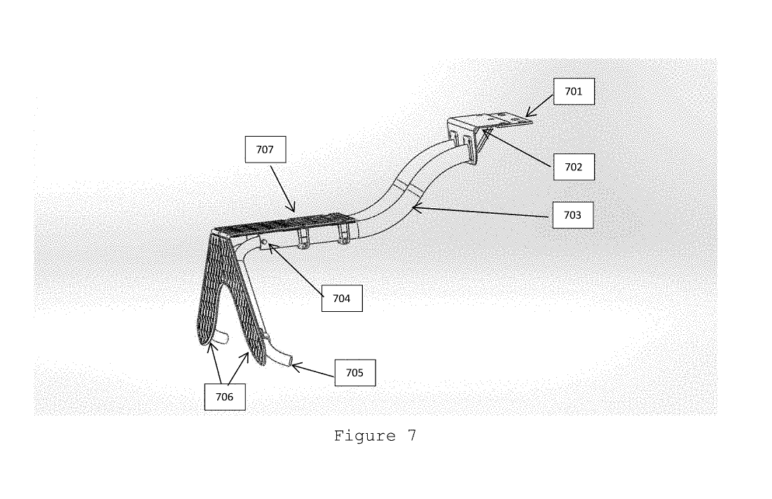

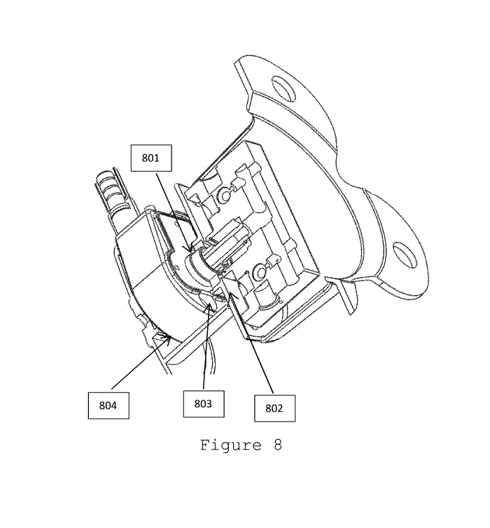

FIG. 7 is a drawing showing the external bracket mounting apparatus. Metal plate 701 is for mounting on a truck chassis, and the L shape metal plate 702 mounting on 701 for supporting the two metal tubes 703. Top cover 707 is mounted on the two metal tubes 703 and joining with hinges to the two side covering flaps 706. The guiding metal tubes 705 are attached to the respective inner side of flaps 706. One end of the smaller guiding tube 705 inserts into the larger metal tube 703 and is secured with screw 704. The air hose and signal cable buddle goes through conducting tubes 703 and 705 for connection from the wheel valve assembly to the electronic manifold controller.

FIG. 8 is a drawing showing the hubcap cover with rotary wheel valve assembly and air hose connector. A carbon alloy brush 801 provides electrical ground connection. An embedded magnet 803 is installed on the air hose connector 804 and provides magnet trigger signal for magnet sensor on PCB 802 of the rotary wheel valve assembly. When the vehicle moves, the magnet sensor on the electronic circuitry in the rotating rotary wheel valve can detect the presence of the magnetic field whenever passing by the magnet, and therefore is able to count the number of wheel rotation for calculating the distance of the vehicle traveled and detecting locked wheels.

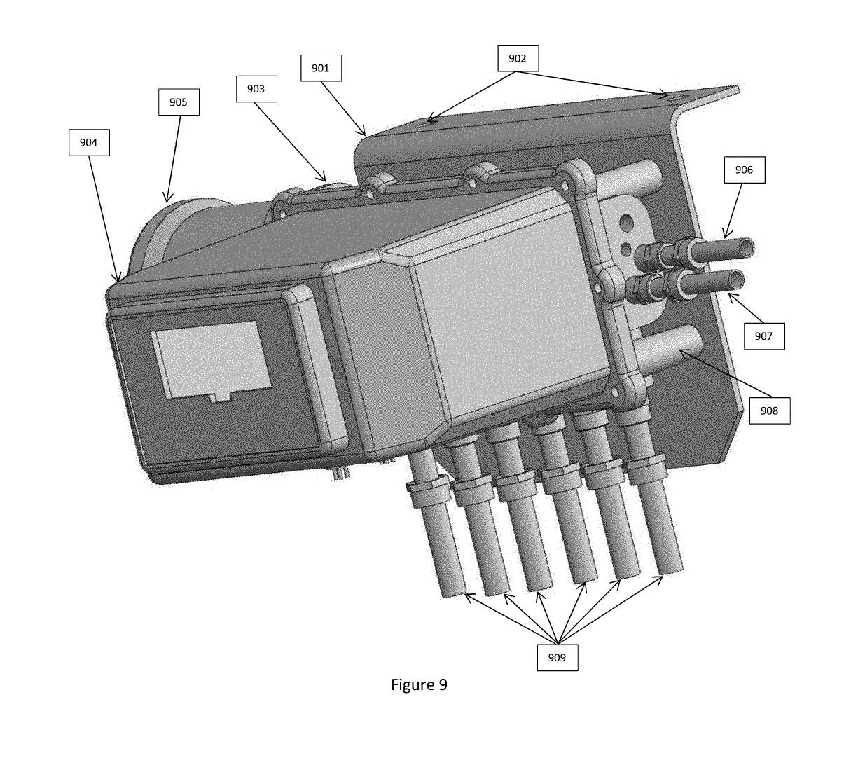

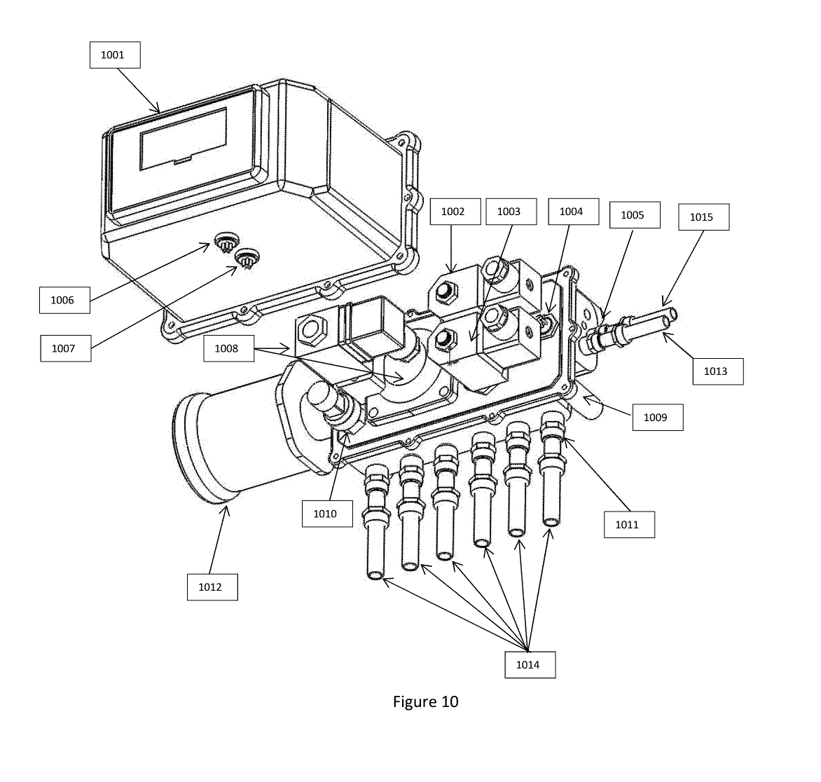

FIG. 9 is a drawing showing the electronic manifold controller secured on a mounting plate. Mounting plate 901 with mounting holes 902 is for mounting the electronic manifold controller 903 on the vehicle chassis. The electronic manifold controller has 4 legs 908 with screw holes for attaching the mounting plate. The electronic manifold controller has a weatherproof cover 904. Noise reduction muffler 905 is for suppressing the loud noise produced by the pressurized air rapidly releasing from quick exhaust valve 1008 (FIG. 10) when closing the rotary wheel valves. Air source inlet 907 takes in pressurized air input from the vehicle air compressor for inflation and deflation operations. The other air inlet 906 takes in the pressurized air input from the vehicle air springs for calculating vehicle load. A different method of measuring vehicle weight is through collection wireless load sensor data by the electronic manifold controller. Air ports 909 connect to the respective rotary wheel valve via air tubes going through the mounting bracket hollow tubes. Each air tube is bundled with a wire for connecting the electronic manifold controller with the rotary wheel valve; the wire is for providing power to wheel valve electronics and for data communication.

FIG. 10 is a drawing showing the inside of the electronic manifold controller. The electronic manifold controller cover 1001 can be plastic or metal and is weatherproof. Connector 1006 is for connecting to an external display unit and power source. Connector 1007 is for connecting to each rotary wheel value with wire for providing power and for data communication. The manifold has an air chamber inside that is connecting to deflation solenoid valve 1002, inflation solenoid valve 1003, quick exhaust solenoid valve 1008, pressure transducer 1010, and air ports 1014. Pressure transducer 1010 monitors the air pressure in the manifold air chamber. The normally close inflation valve 1003 can be opened and let in through air inlet 1013 the pressurized air from the vehicle compressor for opening the wheel valve and inflating tire pressure. The normally closed deflation valve 1002 can be opened to release tire air through a deflation orifice to the atmosphere; the manifold controller would manage the pressure for keeping the rotary wheel valves to stay open during the deflation period. Priority pressure sensor 1004 connects to air inlet 1013 and monitors the vehicle compressor pressure level to ensure that the manifold controller would not perform tire inflation when the compressor pressure is at or below a safe level to support normal vehicle braking operation. Load sensor 1005 connects to air springs inlet 1015 and monitors vehicle suspension air springs pressure for the manifold controller to calculate current vehicle load, thus enabling the system to determine if vehicle tire pressure needs to be adjusted with respect to full vehicle load, half load and empty load for keeping tires in optimal pressure condition. A different way of vehicle weight measurement is through collecting wireless load sensor data by the electronic manifold controller. The 1009 is one of the four legs with screw ports for securing the manifold on the mounting plate.

The manifold air chamber and the connecting air tubes and the wheel valves are normally not pressurized. Whenever necessary, the system will conduct a sequence of steps to perform tire pressure adjustment. In a pressure adjustment procedure, the system will first monitor air source through priority pressure sensor 1005 to ensure there is sufficient air pressure to support the system operation. Next the system will close the normally open quick exhaust valve and open the inflation valve for building up manifold air chamber pressure to a level that will cause the opening of all rotary wheel valves connecting to the tires. If there are no flat or leaky tires, tire air would flow through the opened wheel valves, balance through the manifold air chamber and thereby achieves tire pressure equalization. The system would use pressure transducer 1010 to measure manifold chamber air pressure for determining current tire pressure. If the manifold chamber pressure is lower than target set point pressure then the system would open the inflation solenoid valve and fill up the tires to the desired pressure level with source air. If the tire pressure is higher than the desirable level then the deflation solenoid valve will be opened for releasing air. During inflation or deflation, whenever manifold chamber pressure reaches the target set point, the system will open the quick exhaust solenoid valve to rapidly release the pressurized air in the manifold chamber, the air tubes and the valves that will cause the immediate closing of all rotary wheel valves.

In a normal vehicle operation, when the vehicle starts up the system will carry out the pressure adjustment procedure once to establish proper operating tire pressure. During the vehicle travelling trip, the system will continuously collect tire pressure and temperature information in real time from the wheel valves sensors but does not adjust the tire pressure until pressure variation exceeded a predetermine tolerance. If a tire leak develops and causes pressure slowly to drop then a warning will be issued, meanwhile the system will try to maintain the tire pressure through inflation to compensate for the gradual air loss. If a tire blowout occurred and caused air loss rapidly, however, the system will not attempt to maintain the tire pressure but issue a warning to alert the driver. In a normal vehicle operation the tires will get hot after a prolong drive, and the tire pressure could be substantially higher than cold tire pressure, in this case the system will deflate tire pressure to the desired level for protecting the tires. When tires cool down and the pressure drops down, the system will be adjust the tire pressure back to the normal level. With the load sensor 1015 measuring pressure data from the vehicle air springs, this intelligent system can determine the vehicle load (e.g., full/half/empty) for automatically adjusting tire pressure in accordance to the tire manufacturer's recommended tire pressure with respect to load. The system also supports manual selectable adjustment of tire pressure based on vehicle load such as full/half/empty load and road conditions such as snow, mud, sand, highway, or cross country driving. The system also has a fail-safe operating procedure when the tire data becoming unavailable (e.g., wheel valve electronics went down). In this situation the system will automatically perform tire pressure adjustment every half hour or so.

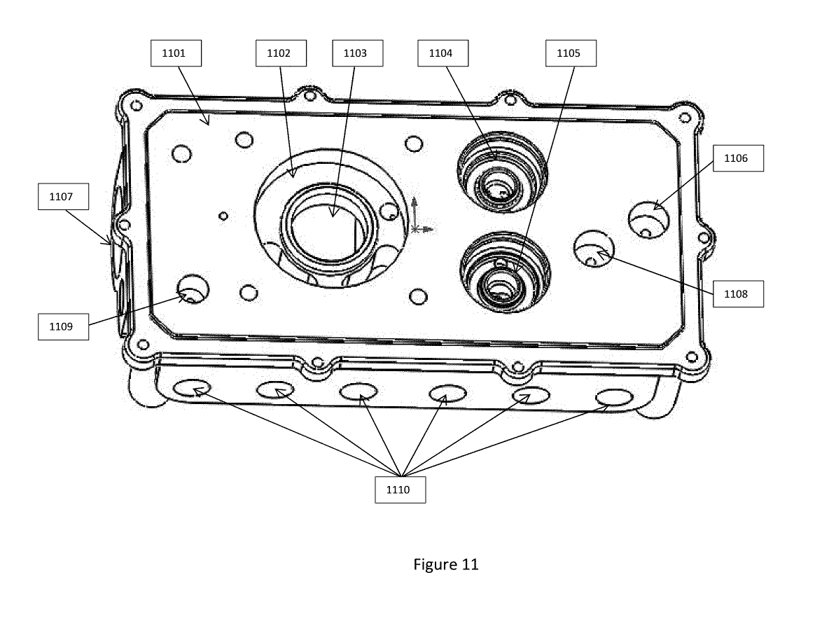

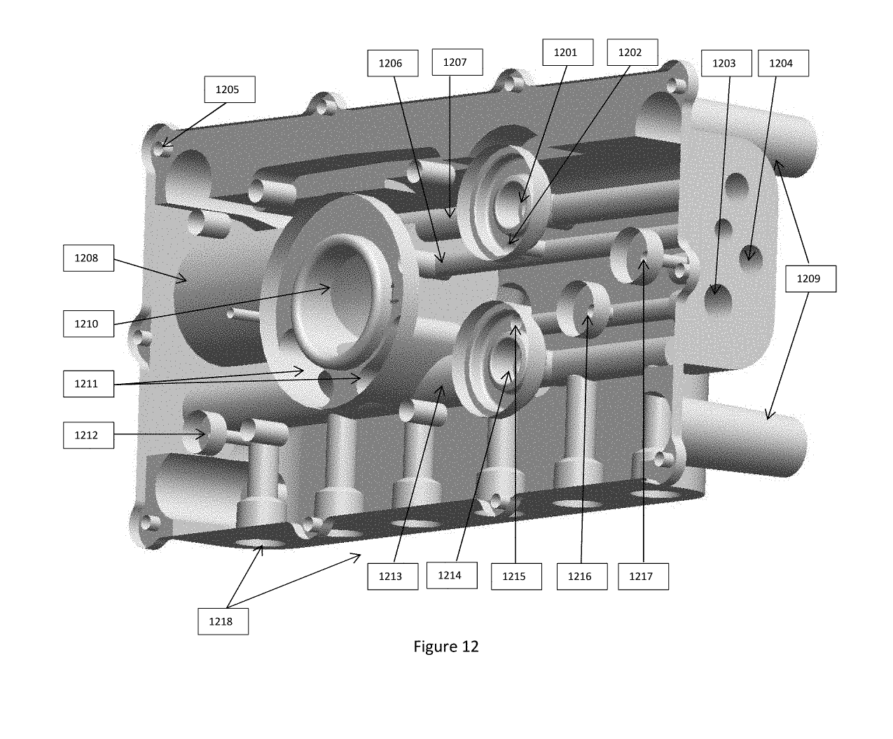

FIG. 11 is a drawing of the electronic manifold controller base without the components. The 1101 is a metal manifold base. The pressure transducer mounting hole 1109 connects to the manifold air chamber for the mounted pressure transducer to monitor the manifold air chamber pressure. The quick exhaust valve cavity 1103 is connected through an inside passage to air outlet 1107 that opens to the atmosphere; air outlet 1107 would be fitted with a noise reduction muffler. The quick exhaust valve is also connected with the manifold air chamber through cavity 1102. The 1104 is the deflation valve cavity and 1105 is the inflation valve cavity. The 1108 is the priority pressure sensor mounting hole and the 1106 is the load sensor mounting hole. Manifold air ports 1110 communicate to all rotary wheel valves through the connecting air tubes.

FIG. 12 is an electronic manifold controller base section inside drawing. Deflation solenoid valve cavity 1202 communicates with manifold chamber 1211 through an air passage. Deflation valve also communicates with cavity 1201 that, through air passage 1207, connects to cavity 1208 that opens to the atmosphere through an orifice. Cavity 1201 has a deflation orifice restricting air releasing speed for maintaining a proper wheel opening pressure during deflation. When deflation valve opens, manifold chamber air will flow out from the manifold chamber through the previous described air paths to the atmosphere. To increase manifold chamber air pressure, solenoid inflation valve is activated to open up the air path for air flowing from inlet 1203 into inflation valve cavity 1215 and then through cavity 1214 flowing into the manifold air chamber 1211. The priority pressure sensor can monitor air source pressure from sensor mounting hole 1216. The load sensor can monitor vehicle load pressure from sensor mounting hole 1217 which is connects to the vehicle suspension air springs pressure inlet 1204. To close all rotary wheel valves, quick exhaust solenoid valve is opened to quickly release air in manifold chamber 1211 through the large exhaust hole 1210 leading to atmosphere hole 1208. The hole 1212 is mounted with the pressure transducer for monitoring the manifold chamber air pressure. The manifold chamber air ports 1218 connect to all rotary wheel valves by air tubes. Screw hole 1205 is one of the ten holes for securing the weatherproof cover on the manifold controller base with screws. Each of the four legs 1209 on the manifold base has threaded hole for securing on the mounting plate with a screw.

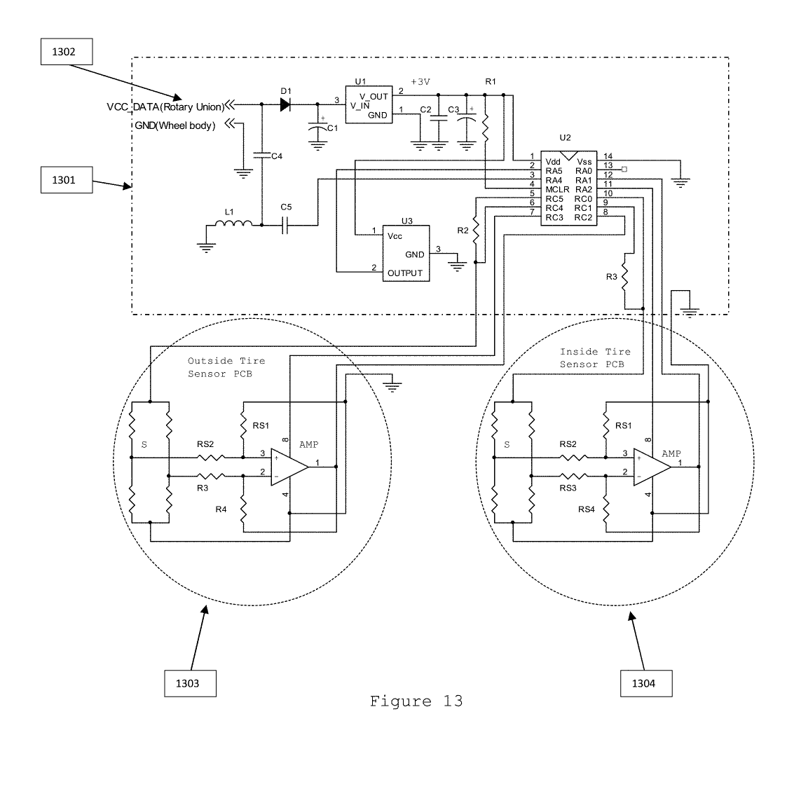

FIG. 13 shows a schematic of the rotary wheel valve electronic circuitry. One electronic unit works with two wheel valves and consists of a data processing PCB 1301 and two sensor PCBs 1303 and 1304. Each sensor PCB contains a piezoresistive pressure sensor S, resistors RS1, RS2, RS3, RS4 and a micro-power amplifier AMP. Sensor S comprises four strain resistant sensitive resistors diffused in silicon. These resistors are connected in a Wheatstone bridge configuration, whereby two resistors increase resistance with positive pressure while the other two resistors decrease in resistance. When pressure is applied to the sensor, the resistors in the arms of the bridge of the sensor changed resistance by an amount directly proportional to the pressure applied. When a voltage is applied to the bridge, there will be a resulting differential output voltage based on arms resistance that can be used to calculate the sensed tire pressure. The micro-power amplifiers AMP with resistors RS1-RS4 condition the sensed tire pressure voltage to a high level for A/D conversion. These two sensor PCBs are secured in locations 207 (FIG. 2a) of the two rotary wheel valves are fully sealed. Each sensor PCB has four wire terminals connecting to the data processing PCB 1301.

The data processing PCB 1301 is installed in location 206 of the rotary wheel valve unit 209 (FIG. 2). The positive voltage power from electronic manifold controller 101 (FIG. 1) to rotary wheel valve unit, as described in the FIG. 2a description, is connected to VCC/DATA input terminal 1302 of data processing PCB 1301 and further connected to protection diode D1 and coupling capacitor C4. As described in the FIG. 2a description, the power input from electronic manifold controller 101 can be connected directly to the PCBs of the rotatable rotary wheel valve unit 209. The input wire is connected to rotary union shaft 210 so that input power passes through the carbon alloy brush in the rotary wheel valve assembly and reaching the PCBs. To establish a stable power supply, PCB 1301 includes low-drop power regulator U1 for converting input voltage to +3V and together with capacitor C1 will stabilize the voltage. A high performance CMOS eight-bit microprocessor U2 with filter capacitors C2 and C3 processes data, controls I/O and manages power. The data processing PCB 1301 further consists one micro-power magnet sensor U3 plus a high frequency serial resonance filter connecting to CPU modulated data output U2's pin3. The tire pressure voltage signals from two sensor PCBs are inputs to the PCB 1301's on-chip A/D converter of microprocessor U2 for producing the tire pressure measurements in digital form. To reduce component cost, this PCB 1301 design utilizes one microprocessor to process inputs from both pressure sensors and then combines the dual tire pressure data to form a single message for high frequency signal transmission through the power line back to the electronic manifold controller.

For reducing the PCB circuit size, an internal 4 MHz RC oscillator is used to clock the microprocessor U2. Under program control, microprocessor U2 outputs an encoded digital message data string for amplitude shift keying modulation with the high frequency carrier signal coming from the internal pulse-width modulator (PWM) circuit. The U2 outputs include the dual tire temperature readings that are calculated from sensor S data sent to respective U2 pin 6 and pin 10 through serial resisters R2 and R3 connection.

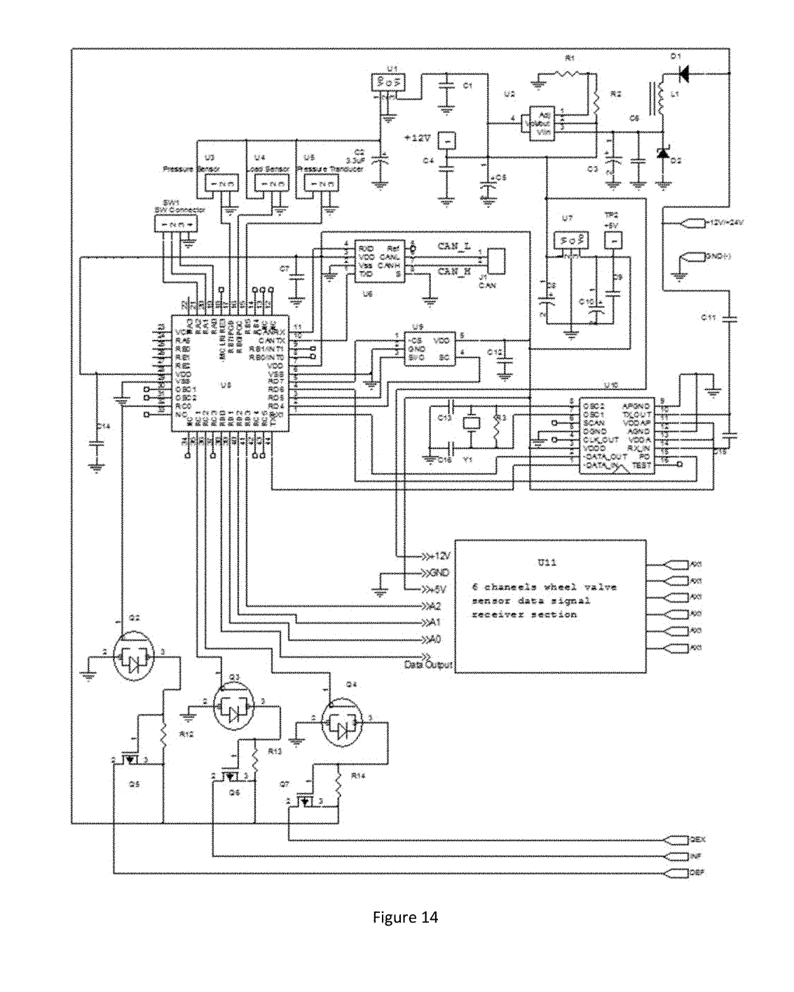

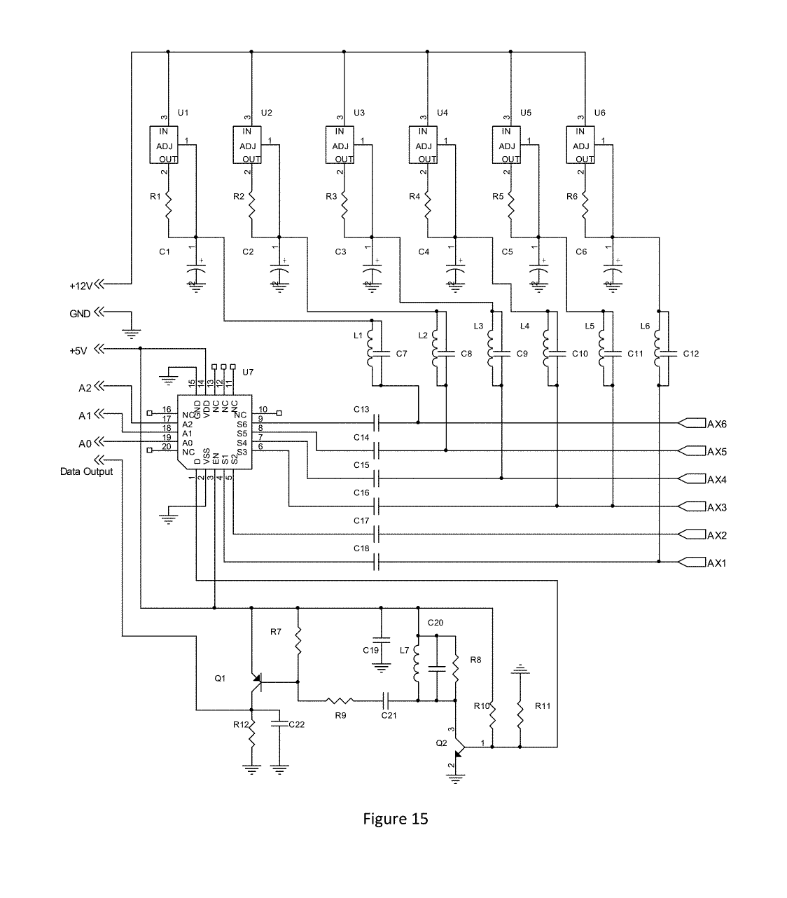

FIG. 14 shows an electronic manifold controller schematic diagram for the electronic design of the power module, communication module, central data processing module, temperature sensor module, pressure sensor module, solenoid driver module and rotary wheel valve electronic unit power/data processing module. The power module includes power protection circuitry with one +12V regulator U2, one +5V precision regulator U1 and one +5V high current regulator U7. The communication module includes one CAN bus driver U6 and one power line communication transceiver U10 to handle data communication between the electronic manifold controller and user display devices installed on the vehicle. The central data processing module has a high performance central processor unit U8 to process all data, handle input and out, and intelligently manage tire pressure with respect to vehicle load and terrain conditions. The temperature module is a precision temperature sensor U9 that provides environment temperature for system sensor automatic calibration. The pressure sensor module includes one priority pressure sensor U3, one air springs load sensor U4 and manifold transducer U5. The solenoid driver module includes pre-driver Q2, Q3, Q4 and high power driver Q5, Q6, Q7 to active deflation solenoid valve, inflation solenoid valve and quick exhaust solenoid valve. This electronic manifold controller schematic diagram shows support for up to 6 trailer tires. The circuit design can be easily modified to support more or less tires. The power supply and data processing module U11 for rotary wheel valve electronic unit 209 is descripted next in FIG. 15 discussions.

FIG. 15 shows the U11 circuitry that supports providing stable power to the rotary wheel valves electronic unit 209 from electronic manifold controller 101 and performing data demodulation using the same power wire. Power from the electronic manifold controller must pass through the rotary union with carbon brush grounding contact to reach the rotary wheel valves electronics, and then return to the ground through the hubcap cover built-in rotary carbon brush contactor. It is technically very challenging to maintain stable power supply through carbon brush contact and at the same time support reliable data and control signal communication between the two devices. Since the carbon brush contact electrical resistance might change randomly from several ohm's to over 10K ohm and would cause the current flow to fluctuate if the voltage remains constant, it is necessary to be able to dynamically adjust the voltage level with respect to the resistance changes for maintaining a stable power supply. The FIG. 15 schematic diagram shows circuit design to support 6 power lines, where U2 to U6 are six current limiters providing stable power to rotary wheel valves electronics through the respective AX1 to AX6 connection. The R1 to R6 are current sensing resistors and the C1 to C6 are filter capacitors for suppressing interfering electronic noise. To transmit data over the noisy DC power line, sensor data is modulated by a high frequency carrier. The six parallel resonance loops L1-L6 and C7-C12 show high impedance for carrier frequency and show low resistance for DC to power AX1 to AX6. The coupling capacitors C13-C18 remove the DC elements and only pass AC signals into multiple-switch U7. By selecting A0-A2 level with the CPU, UV can be switched to one of the AX1-AX6 inputs, and the output signals from U7 is connected to the following carrier amplifier that is composed of one NPN transistor Q2, base bias resistors R10-R11 and carrier resonance loop L7-C20-R8. The NPN transistor Q2 outputs the carrier signal through C21 and R9 to data detector Q1 with R7, and C22 for data demodulation.

The above system and methods describe a preferred embodiment using exemplar devices and methods that are subject to further enhancements, improvement and modifications. However, those enhancements, improvements modifications may nonetheless fall within the spirit and scope of the appended claims.

### ADDITIONAL PREFERRED EMBODIMENTS AND SCOPE

The above preferred embodiment illustrated a typical embodiment of the present invention. Although the description above contains much specificity, these should not be construed as limiting the scope of the invention but as merely providing illustrations of some of the presently preferred embodiments of this invention. There are various possibilities with regard to additional embodiments. Thus the scope of the invention should be determined by the following claims and their legal equivalents, rather than by the examples given.

What we claim as our invention is:

1. A rotary wheel valve assembly to be utilized in a tire inflation and deflation system on a vehicle with single or dual tires, comprising:
[A] wheel valve means, comprising:
[I] a valve body having an air inlet passageway and an air outlet passageway for air communication;
[II] a bottom chamber in said valve body connecting to said air inlet passageway;
[III] a middle chamber separating from said bottom chamber by a flexible diaphragm, connecting to said air inlet passageway through an orifice, having:
a. a piston movable within said middle chamber engaging to said diaphragm for movement with said diaphragm;
b. a valve seat;
[IV] a top chamber disposed proximate to said middle chamber, having:
a. air passageway means connecting to said air outlet passageway for air communication;
b. a poppet sitting on said valve seat and separating the top chamber and the middle chamber, said poppet engaging said piston in the middle chamber and movable relative to said piston;
c. spring means compressively urging said poppet toward seating disposition;
[B] rotary union means, comprising:
[I] a casing defining a chamber, said casing having an air passage connecting to said chamber;
[II] a rotatable shaft mounted in said chamber, said shaft having a central air passageway, said shaft having a seal face with a central hole on one end and an air passage end extending beyond said chamber;
[III] a second seal face fitting inside said chamber in an airtight sealing engagement to said shaft seal face, said second seal face having a central hole for air communication between said shaft air passage and said casing air passage;
[C] housing means, having:
[I] two cavities inside said housing, each containing one said wheel valve;
[II] a structure built into middle of said housing containing said rotary union;
[III] an opening on top of housing allowing said rotary union shaft extending out for connection with external air source;
[IV] air passageway means inside said housing establishing air communication for said rotary union, wheel valves, and tires.

2. A wheel valve for vehicle tire inflation and deflation applications, comprising:
[A] a valve body having an air inlet passageway and an air outlet passageway;
[B] a bottom chamber in said valve body connecting to said air inlet passageway;
[C] a middle chamber separating from said bottom chamber by a flexible diaphragm, connecting to said air inlet passageway through an orifice, having:
[I] a movable piston with the bottom end engaging to said diaphragm for movement with said diaphragm;
[II] a valve seat;
[D] a top chamber disposed proximate to said middle chamber, having:
[I] air passageway means connecting to said air outlet passageway for air communication;
[II] a poppet sitting on said valve seat and separating the top chamber and said middle chamber, said poppet engaging top end of said piston in said middle chamber and movable relative to said piston;
[III] spring means compressively urging said poppet toward seating disposition.

3. The rotary wheel valve assembly of claim 1, further including electronic monitoring means with electronic components mounting on print circuit boards, comprising:
[A] pressure and temperature sensor means for measuring fluid pressure and temperature within the top chamber of each said wheel valve;
[B] magnetic sensor means for detecting the magnetic field produced by a magnet to be installed nearby;
[C] control means receiving said pressure and temperature sensor data for calculating tire pressure and temperature in real time, receiving magnetic field detection data for counting wheel rotations, and communicating with an external device;
[D] power supply means for powering up the electronics.

4. The rotary wheel valve assembly of claim 1, further including a hubcap cover assembly, comprising:
[A] a hubcap cover for installation on top of a vehicle axle hubcap;
[B] an opening on top of said hubcap cover allowing rotary shaft of said rotary wheel valve to pass through;
[C] mounting means for securing said rotary wheel valve assembly in interior of said hubcap cover;
[D] batteryless power supply means connecting external power to rotary shaft and leading into rotary wheel valve electronics;
[E] electrical grounding means for providing rotary contact to a grounding terminal of said hubcap cover;
[F] connector means for connecting rotary union shaft air outlet to external air passage tubing.

5. The rotary wheel valve assembly of claim 1 further including a method of providing electrical power and supporting electronic communication through wire to said rotary wheel valve mounted on a rotating vehicle wheel, comprising:
[A] a wire having one end connecting to the rotary union shaft in said rotary wheel valve and the other end connecting to an external device, said wire carrying power from said external device passing through the rotary union electrical conductive contact and reaching the positive terminal of the rotary wheel valve electronics;
[B] a wire connecting the wheel valve electronics negative terminal through a rotary conductive brush ground terminal built into the hubcap cover;
[C] data modulation with high frequency carrier means on said power supply wires supporting electronic communication between said wheel valve electronics and said external device.

6. An apparatus for adjusting the air pressure in a dual tire of a vehicle, comprising:
[A] a source of pressurized air;
[B] an electronic rotary wheel valve assembly built into a hubcap cover disposed on the top of a vehicle axle hubcap for connecting each of said dual tire in fluid communication with said wheel valve assembly, comprising:
[I] a rotary wheel valve assembly having a rotary union and two wheel valves, each of said wheel valves being pneumatically controllable to open and remaining open for fluid communication, and pneumatically controllable to close for shutting off fluid communication, said wheel valve having electronic circuitry monitoring tire pressure in real time and communicating with an external device;
[II] hubcap cover means for having said assembly mounting on the top of said hubcap;
[III] installation means for mounting said hubcap cover with said assembly on top of said vehicle axle hubcap, connecting an air path to said rotary wheel valve air inlet, and connecting said rotary wheel valve air outlets to respective tire;
[C] an electronic control manifold assembly, including:
[I] a manifold assembly including:
(a) a housing with an air tight manifold chamber;
(b) fluid communication means including tubing means for connecting said manifold chamber to said air path of said rotary wheel valve assembly;
(c) valve means, comprising:
(i) inflation solenoid valve connecting to said manifold chamber and to said air source;
(ii) deflation solenoid valve connecting to said manifold chamber and to atmosphere through a deflation orifice;
(iii) quick exhaust valve connecting to said manifold chamber and to atmosphere through a noise reduction muffler;
(d) priority pressure sensor means monitoring said air source pressure level;
(e) transducer means monitoring said manifold chamber air pressure level;
(f) vehicle load processing means monitoring vehicle weight sensor inputs for calculating vehicle load;
[II] control means receiving pressure data from said priority sensor, wheel valve sensors and manifold chamber transducer, and in response controlling the opening and closing of different valves in said apparatus for adjusting pressure level in said tires;
[D] installation means for mounting said apparatus on a vehicle.

7. The installation of claim 6, further including external mounting apparatus supporting two set of dual tires on one side of a vehicle, comprising:
[A] One or more rigid plates with multiple slot openings for adaptive mounting on a vehicle chassis in a positon near the outside center line between two drive axles;
[B] two rigid tubes each with one end securable on said rigid plate and the other end extending toward the side of a vehicle;
[C] rigid top platform means securable on said rigid tube extensions for forming a strong structure;
[D] two guiding tubes each with curvature having one end adaptively securing to a respective rigid tube and the other end extending toward respective dual tire wheel valve assembly;
[E] two air hoses each with one end connecting to the manifold and the other end going through inside of respective said rigid tube and said guiding tube and coming out for respective dual tire wheel valve assembly connection;
[F] two connectors for connecting said air hoses with respective dual tire rotary wheel valve assembly air inlet, enabling air communication during wheel rotation;
[G] two vehicle side covering flaps each joining to said top platform with hinge for up and down position adjustment, inner side of said flaps securing to respective guiding tube for forming a protective shield.

8. The apparatus of claim 6, further including user interface means, comprising:
[A] a CAN bus between the electronic manifold assembly and user display unit for entering user commands and control;
[B] a LCD display control unit for showing information and status and issue control command;
[C] alarm means for warning driver of abnormal tire condition such as a tire blowout;
[D] Cab mounting monitoring means including keypad and LCD screens changeable by pressing certain key sequences on the keypad for selectively showing tire pressure monitoring information or central control tire management information for controlling said functions.

9. The electronic control manifold assembly of claim 6, further including load sensitive automatic tire pressure adjustment means, comprising:
[A] vehicle weight sensor means measuring vehicle weight variations in real time;
[B] control means receiving said sensor data for determining vehicle load and adjusting tire pressure in accordance to user defined criteria.

10. The control means of claim 6, further including manual tire pressure adjustment means, allowing user selection of predetermined tire pressure level, including:
[A] load related adjustment means based on selected vehicle load level of full load, half load, or empty load;
[B] terrain related adjustment means based on selected road condition of snow, mud, sand, highway, or cross country driving.

11. An apparatus as defined in claim 6 in which said control means further including system operation means, comprising:
[A] wheel valve opening procedure means including measuring air source pressure for determining operability of apparatus, closing the normally open quick exhaust valve, measuring air pressure in manifold chamber, opening the inflation valve for a brief time for filling manifold chamber and the connecting rotary wheel valves with sufficiently pressurized air for opening all wheel valves;
[B] wheel valve shutoff procedure means including opening quick exhaust valve and releasing pressurized air from manifold chamber and air tubes for causing rotary wheel valves to shut off;
[C] inflation procedure means including opening the inflation value to fill source air to the tires;
[D] deflation procedure means including opening the deflation value to release air through the deflation orifice while maintaining sufficient air pressure for keep wheel valves open;
[E] target tire pressure setup procedure means establishing tire pressure set point based on predetermine optimal tire pressure, pressure level with respect to vehicle load or user selection based on terrain condition;
[F] system adjustment procedure means including conducting target tire pressure setup procedure, conducting wheel valve opening procedure, allowing tires reaching air pressure equalization through the manifold chamber, comparing manifold chamber pressure against desired tire pressure set point, conducting inflation procedure if manifold chamber pressure is lower than set point or conducting deflation procedure if chamber pressure is higher, conducting wheel valve shutoff procedure when target pressure set point is reached;
[G] start-up operation means for vehicle starting up including conducting a system diagnostics process and conducting said system adjustment procedure;
[H] dynamic operation means for monitoring and adjusting pressure from all wheel valves when vehicle is on motion, including:
[I] monitoring means including collecting real time tire sensor data from wheel valve electronics, detecting high pressure or low pressure tire condition, and determining tire blowout and slow leak and issuing warnings accordingly;
[II] high pressure adjustment means including opening wheel valve and releasing air for protecting possibly overheating tires, and opening quick exhaust valve to close all wheel valves when tire pressure coming down to a safe level;
[III] low pressure adjustment means including opening wheel valve and inflating air until reaching target set point, and then opening quick exhaust valve to close all wheel valves;
[IV] blow out warning means including issuing warnings and not conducting any pressure adjustment procedures;
[V] fail-safe operation means periodically checking tire pressure and conducting system adjustment procedure for adjusting tire pressure to the desired level.

12. An apparatus as defined in claim 6 further including mileage counter, locked wheel detection and overheating tire monitoring functions, comprising:
[A] a temperature sensor on each wheel valve measuring temperature;
[B] a magnet installing on a plate affixed to the rotary union shaft for triggering the magnetic sensor in the hubcap mounted wheel valve assembly when the vehicle wheels are rotating;
[C] wheel rotation count means counting number of wheel rotation based on said magnetic sensor data;
[D] mileage computing means calculating vehicle distance traveled based on wheel rotation counts and tire size;
[E] locked wheel detection means determining if any wheel is not rotating in a moving vehicle;
[F] overheating tire detection means monitoring abnormal tire temperature rising possibly caused by broken bearings, stuck axles or jammed brakes.
